(19) United States
(12) Patent Application Publication
(10) Pub. No.: US 2006/0179943 A1
(43) Pub. Date: Aug. 17, 2006

(54) ELECTRONIC CIRCUIT INCLUDING A LOW NOISE LEVEL CAPACITIVE SENSOR AND ACCELEROMETER FITTED WITH THE SAME

(75) Inventors: Michel WILLEMIN, Preles (CH); Beat Pfefferli, Thielle-Wavre (CH)

Correspondence Address: SUGHRUE MION, PLLC, 2100 PENNSYLVANIA AVENUE, N.W., SUITE 800, WASHINGTON, DC, 20037, US

(73) Assignee: EM MICROELECTRONIC - MARIN SA

(21) Appl. No.: 11/276,303

(22) Filed: Feb. 23, 2006

(30) Foreign Application Priority Data
Feb. 15, 2005 (EP) 05003183.0

(51) Int. Cl. G01P 15/125

(52) U.S. Cl. 73/514.32

(57) ABSTRACT

The invention concerns an electronic circuit (10) for measuring a force, including a capacitive sensor (12) connected to a capacitive bridge (14), of the type wherein the capacitive sensor (12) includes a moving electrode (16) suspended elastically between a first (18) and a second (20) fixed electrode so as to form respectively a first (C1) and a second (C2) capacitor whose capacitance is variable, of the type wherein the capacitive bridge (14) generates an electric output signal (Vs), which is a function of the capacitance variations of the capacitors (C1, C2), of the type wherein the capacitance value of each capacitor (C1, C2) is substantially lower than one picofarad, when the moving electrode (16) occupies a rest position, and of the type wherein the excitation frequency of the circuit (10) is comprised overall within the low frequency range, characterised in that a series impedance element (26, 28, 30) is interposed between each of the three electrodes (16, 18, 20) and the capacitive bridge (14) so as to form a low-pass filter.

The invention also proposes an accelerometer fitted with this circuit (10).

This application claims priority from European Patent Application No. 05003183.0 filed Feb. 15, 2005, the entire disclosure of which is incorporated herein by reference

The invention concerns an electronic force measurement circuit; in particular a circuit including a capacitive sensor electrically connected to a capacitive bridge and intended to be arranged in an accelerometer so as to measure an inertia force corresponding to an acceleration.

In this type of electronic circuit the capacitive sensor includes a moving electrode suspended elastically between a first and a second electrode fixed to form respectively first and second capacitors with variable capacitance. The capacitive bridge generates an electric output signal which is a function of the capacitance variations of the capacitors and which is representative of a force applied to the capacitive sensor, or an inertia force that the capacitive sensor undergoes, for example an acceleration measurement. The capacitance value of each capacitor is slightly less than one picofarad, when the moving electrode occupies a rest position; equidistant from each fixed electrode, and the excitation frequency of the circuit is comprised overall within the low frequency range.

An electronic circuit of this type is disclosed in particular in an article by H. Leuthold and F. Rudolph in the journal “Sensors and Actuators” A21-A23 (1990), pages 278 to 281.

With this type of electronic circuit, noise problems can appear in the acceleration measurements. These problems arise particularly during significant variations in the current intensity and/or during current peaks caused by voltage switches in the capacitive bridge and/or during induced electrostatic force peaks.

Moreover, when this type of electronic circuit is arranged in an accelerometer fitted with several capacitive sensors, coupling phenomena appear between the capacitive sensors, which causes interference in the acceleration measurements. Such coupling can occur via the signals common to the capacitive sensors, for example through the current supply.

It is an object of the invention to overcome these drawbacks.

Therefore, the invention proposes an electronic circuit of the type previously described, characterized in that a series impedance element is interposed between each of the three electrodes and the capacitive bridge in order to form a low-pass filter.

Owing to the arrangement according to the invention, the negative effects of current peaks are limited.

According to an advantageous embodiment of the invention, the series impedance element is a resistor.

The invention is particularly suited to improving the operation of a capacitive bridge with charge compensation.

The invention also proposes an accelerometer characterized in that it includes an electronic circuit according to one of the preceding features, and in that it includes at least two capacitive sensors which measure acceleration values respectively in at least two directions, each capacitive sensor being connected to an associated capacitive bridge with insertion of series impedance elements.

Other features and advantages of the present invention will appear more clearly upon reading the following detailed description, made with reference to the annexed drawings, given by way of non-limiting example and in which:

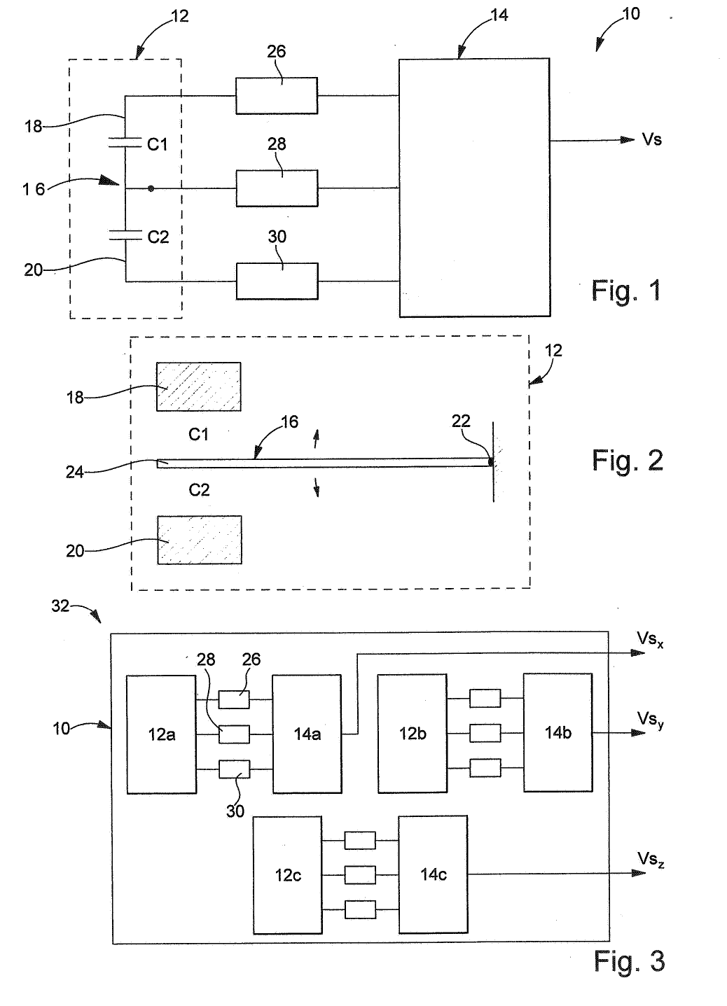

FIG. 1 is a diagram showing an electronic circuit in accordance with the teaching of the invention for measuring an inertia force corresponding to an acceleration;

FIG. 2 is a schematic diagram showing the capacitive sensor fitted to the electronic circuit of FIG. 1;

FIG. 3 is a diagram showing an accelerometer in accordance with the teaching of the invention fitted with an electronic circuit including three capacitive sensors.

In the description that follows, similar or identical elements will be designated by the same references.

FIG. 1 shows schematically an electronic circuit 10 in accordance with the teaching of the invention for measuring an inertia force corresponding to an acceleration.

Electronic circuit 10 includes a capacitive sensor 12 which is connected across a capacitive bridge 14.

As can be seen in more detail in FIG. 2, capacitive sensor 12 includes a moving electrode 16 elastically suspended between a first 18 and a second 20 fixed electrode. First electrode 18 and moving electrode 16 form a first capacitor C1 whose capacitance is variable, and the second fixed electrode 20 forms, with moving electrode 16, a second capacitive C2 whose capacitance is variable.

According to the simplified embodiment which is shown schematically in FIG. 2, moving electrode 16 has the shape of a conductive strip which is fixed at one of its ends 22 such that its opposite end 24 can move towards one or other of the fixed electrodes 18, 20 when the capacitive sensor 12 is subjected to an acceleration component orthogonal to the conductive strip.

It will be noted that, in accordance with an improved embodiment, the moving electrode 16 has the shape of a comb whose teeth are received in complementary fixed notches delimited by fixed electrodes 18, 20.

When moving electrode 16 occupies a rest position, i.e. in the absence of any acceleration, it is approximately equidistant from each fixed electrode 18, 20, such that the capacitances of the two capacitors C1, C2 are approximately equal.

The operation of such a capacitive sensor 12 is described in particular in the preamble of FR Patent No. A-2,720,510.

Capacitive bridge 14 is provided for generating an electric output signal Vs, which is a function of the capacitance variations of capacitors C1, C2 and which is representative of an acceleration measurement. For this purpose, capacitive bridge 14 includes means (not shown) for measuring the capacitance variations and for comparing the measured variations over the first and second capacitors C1, C2 so as to deduce a suitable electric output signal Vs therefrom.

Preferably, capacitive bridge 14 is of the charge compensation type.

Reference can be made to the article by H. Leuthold and F. Rudolf, and to the preamble of FR Patent No. A-2,720,510, which describe and show a capacitive bridge with charge compensation.

However, the invention also applies to circuits including other types of capacitive bridge such as capacitive bridges with force compensation.

The invention particularly concerns an electronic circuit 10 including a capacitive sensor 12 in which the capacitance value of the two capacitors C1, C2 is very low, i.e. substantially less than one picofarad. For example, the capacitance of capacitors C1, C2 can be equal to 600 femtofarads, or even less. In this type of electronic circuit 10, the capacitance variations of capacitors C1, C2 linked to a variation in the inertia force are extremely low, of the order of several tens of attofarads.

This type of electronic circuit 10 is provided for operating with an excitation frequency overall comprised within the low frequency range, so as to make electronic circuit 10 in the form of a integrated circuit with very low current consumption.

According to the teaching of the invention, a series impedance element 26, 28, 30 is directly interposed between each of the three electrodes 16, 18, 20 and the capacitive bridge 14 so as to form a low-pass filter.

Owing to the presence of these series impedance elements 26, 28, 30, a decrease in noise level is observed during acceleration measurements.

Advantageously, the series impedance elements 26, 28, 30 are resistors of equal value. Each resistor is, for example, substantially less than several hundred kilo ohms.

Thus, it has been observed that, for capacitors C1, C2 of six hundred femtofarads, with an excitation frequency equal to thirty-two kilohertz, the use of resistors 26, 28, 30 of two hundred and seventy kilo ohms allows good noise reduction results to be obtained.

However, the value of resistors 26, 28, 30 could be chosen within a wide range depending upon the excitation frequency of the circuit.

It will be noted that, contrary to what one might have feared, resistors 26, 28, 30 have no negative effect on the precision of the acceleration measurements, or on the sensitivity of such measurements.

FIG. 3 shows an accelerometer 32, which is made in accordance with the teaching of the invention and which includes an electronic circuit 10 like that which has just been described.

Accelerometer 32 is here of the type with three axes, i.e. it enables the value of three components of an acceleration to be measured along three orthogonal axes X, Y, Z. For this purpose, accelerometer 32 includes three capacitive sensors 12a, 12b, 12c which are provided respectively for measuring the value of the three components.

Each capacitive sensor 12a, 12b, 12c is connected across an associated capacitive bridge 14a, 14b, 14c with a resistor 26, 28, 30 interposed between each electrode 16, 18, 20 and the capacitive bridge 14a, 14b, 14c. Each capacitive bridge 14a, 14b, 14c generates an electric output signal Vsₓ, Vs_{y}, Vs_{z} representative of an acceleration along the associated X, Y, Z axis.

Owing to electronic circuit 10 according to the invention, accelerometer 32 has improved measuring reliability. In fact, the presence of resistors 26, 28, 30 improves the uncoupling properties between capacitive sensors 12a, 12b, and 12c such that they no longer disturb each other.

It should be noted that the invention also applies to a circuit including a capacitive sensor used for measuring a force corresponding to an application of pressure on the sensor.

1. An electronic circuit for measuring a force, including a capacitive sensor connected to a capacitive bridge, wherein the capacitive sensor includes a moving electrode suspended elastically between a first and a second fixed electrode so as to form respectively a first and a second capacitor whose capacitance is variable, wherein the capacitive bridge generates an electric output signal, which is a function of the capacitance variations of the capacitors, wherein the capacitance value of each capacitor is substantially lower than one picofarad, when the moving electrode occupies a rest position, wherein the excitation frequency of the circuit is comprised overall within the low frequency range, a wherein a series impedance element is interposed between each of the three electrodes and the capacitive bridge so as to form a low-pass filter.

2. The electronic circuit according to claim 1, wherein the series impedance elements are identical.

3. The electronic circuit according to claim 1, wherein the series impedance elements are resistors.

4. The electronic circuit according to claim 3, wherein the value of each resistor is less than four hundred kilo ohms.

5. The electronic circuit according to claim 1, wherein the capacitive bridge is of the charge compensation type.

6. The electronic circuit according to claim 1, wherein the capacitance of each capacitor is less than or equal to six hundred femtofarads.

7. An accelerometer, wherein it includes an electronic circuit according to claim 1, and wherein it includes at least two capacitive sensors which measure acceleration values respectively in at least two directions, each capacitive sensor being connected to an associated capacitive bridge with the insertion of series impedance elements.

8. The accelerometer according to claim 7, wherein it includes three capacitive sensors which measure acceleration values respectively in three directions orthogonal to each other.
